(19) United States
(12) Patent Application Publication
(10) Pub. No.: US 2009/0283091 A1
(43) Pub. Date: Nov. 19, 2009

(54) Char Broiler Grate Assembly

(76) Inventors: Eric H.Y. Deng, Irvine, CA (US); Yevgeniy Savinskiy, Laguna Hills, CA (US)

Correspondence Address: WOMBLE CARLYLE SANDRIDGE & RICE, PLLC, ATTN: PATENT DOCKETING, P.O. BOX 7037, ATLANTA, GA, 30357-0037, US

(21) Appl. No.: 12/466,463

(22) Filed: May 15, 2009

Related U.S. Application Data
(60) Provisional application No. 61/053,744, filed on May 16, 2008.

(51) Int. Cl. F24C 3/00; F23H 13/00; B23P 19/04

(52) U.S. Cl. 126/41 R; 126/152 B; 29/700

(57) ABSTRACT

A grate assembly that attaches to a range is provided. The grate assembly includes first and second cantilevered supports that receive at least one grate thereupon. The first and second supports are attached to a base that includes openings sized to receive bolts disposed on the range. When the grate assembly is installed, generally on the rear wall of the range, the openings receive the bolts and orient the grate assembly in a horizontal position at a first position above a burner in the fire box of the range. The grate assembly can be raised or lowered to a second position closer or further from the burner if less or more intense heating or cooking is desired.

### CROSS-REFERENCE TO RELATED APPLICATIONS

This claims the benefit of Provisional Application No. 61/053,744, filed May 16, 2008, the entire contents of which are hereby incorporated by reference.

### BACKGROUND

The present disclosure generally relates to a grate assembly for a range, such as a char broiler.

### SUMMARY

Briefly described, a grate assembly for a range comprises a frame including a first support and a second support coupled to a base, and at least one grate. The first support and the second support are configured to receive at least one support element. The base includes at least two bolt receiving holes each sized to receive a bolt disposed on the range for orienting the grate assembly in a generally horizontal orientation in a first position a first distance above a burner on the range. The support element is sized to receive thereon a plurality of grates. The first support and the second support are cantilevered and extend from the base. The first support and the second support intersect the base and taper from a wider rear support proximate the intersection with the base to a narrower front support distal the intersection with the base. The base includes a first side adjacent the first support and a second side adjacent the second support. The first side of the base and the second side of the base each include at least three bolt receiving holes sized to receive at least one bolt or two bolts per side disposed on the range. The support elements include at least two support elements over the first support and the second support, with each support element receiving at least one bar thereupon.

A method of installing grate assemblies in a range also is described. The method includes providing a first grate assembly having a frame including a first support and a second support. The frame is coupled to a base, with the first support and the second support configured to receive at least one support element. The base includes a first bolt receiving hole and a second bolt receiving hole. The method further includes passing the first bolt receiving hole over a first bolt and the second bolt receiving hole over a second bolt, and securing the grate assembly in a substantially horizontal position a first distance over a first burner. The range is sized to receive more than one grate assembly.

A range is disclosed that has a housing including a rear wall and a fire box and at least one burner in the housing. The rear wall includes at least one first bolt spaced from at least one second bolt. The range includes at least one grate assembly having a base, a first support, and a second support. The base has a first end spaced from a second end, with the first support being proximate the first end and the second support being proximate the second end. The base includes at least one bolt receiving opening at the first end and at the second end. The first support and the second support are configured to receive at least one support element therebetween. The at least one grate assembly is installed in a first position with the at least one opening at the first end receiving the at least one first bolt and the at least one opening at the second end receiving the at least one second bolt on the rear wall of the range. Optionally, the at least one bolt receiving opening includes at least three openings at the first end and at the second end. Optionally still, the three openings can be vertically oriented and equally spaced at the first end and at the second end. The at least one grate assembly can receive the at least one first bolt and the at least one second bolt so as to position the grate assembly in one of three distances from the burner. The range can includes two grate assemblies, with a first grate assembly installed at a first position spaced a first distance from the burner and a second grate assembly installed at a second position spaced a second distance from the burner. The first distance and the second distance can be different. Optionally, the first grate assembly can be moved from the first distance to the second distance. The at least one support element receives a plurality of grates.

Other aspects, features, and details of the present disclosure can be more completely understood by reference to the following detailed description, taken in conjunction with the drawings and from the appended claims.

### BRIEF DESCRIPTION OF THE DRAWINGS

According to common practice, the various features of the drawings discussed below are not necessarily drawn to scale. Dimensions of various features and elements in the drawings may be expanded or reduced to illustrate more clearly the embodiments of the disclosure.

FIG. 1 shows a grate assembly according to a first embodiment.

FIG. 2 shows the grate assembly of FIG. 1 installed in a range.

FIG. 3 shows three grates assemblies according to FIG. 1 installed in three positions in a range.

FIG. 4 shows an underside perspective view of a grate assembly according to a second embodiment.

FIG. 5 shows a topside perspective view of the grate assembly of FIG. 4.

FIG. 6 shows three grates assemblies according to FIG. 4 installed in three positions in a range.

FIG. 7 shows a grate assembly according to a third embodiment.

FIG. 8 shows the grate assembly of FIG. 7 with grates applied to the top of the frame.

FIG. 9 shows a grate assembly according to a fourth embodiment.

FIG. 10 shows the grate assembly of FIG. 9 in a range.

FIG. 11 shows a grate assembly according to a fifth embodiment with a finger gap in the grate.

FIG. 12 shows a sixth embodiment with supports extending entirely therealong.

### DETAILED DESCRIPTION OF THE DRAWINGS

For purposes of illustration and not limitation, the disclosure below describes grate designs within the context of grate assemblies for a range. However, any other appropriate articles might be substituted for the grates within the scope of the invention. Further, references herein to “end,” “side,” “bottom,” and “top” refer to orientations or positions of elements when the grate assembly is oriented as if disposed in a range. The terms “upper,” “lower,” “vertical,” and “horizontal,” generally refer to the location and/or orientation of an element with respect to a drawing figure in which it appears.

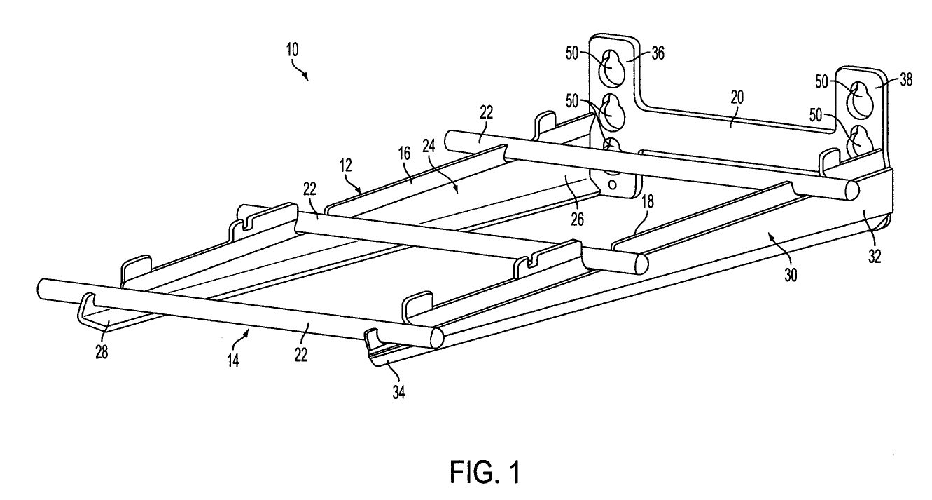

Referring now in more detail to the drawing figures, wherein like reference numerals indicate like parts throughout the several views, FIG. 1 shows a grate assembly 10 according to a first embodiment. The grate assembly 10 includes a frame and a grate disposed on the frame. FIG. 1 omits the grates to show all elements of the frame 12, including a front 14, first side or bracket 16, second side or bracket 18, and base or rear 20. The brackets 16 and 18 are configured to receive crossbar supports 22 (three shown, though more or less could be included as desired). The crossbars 22 can be disposed in different configurations.

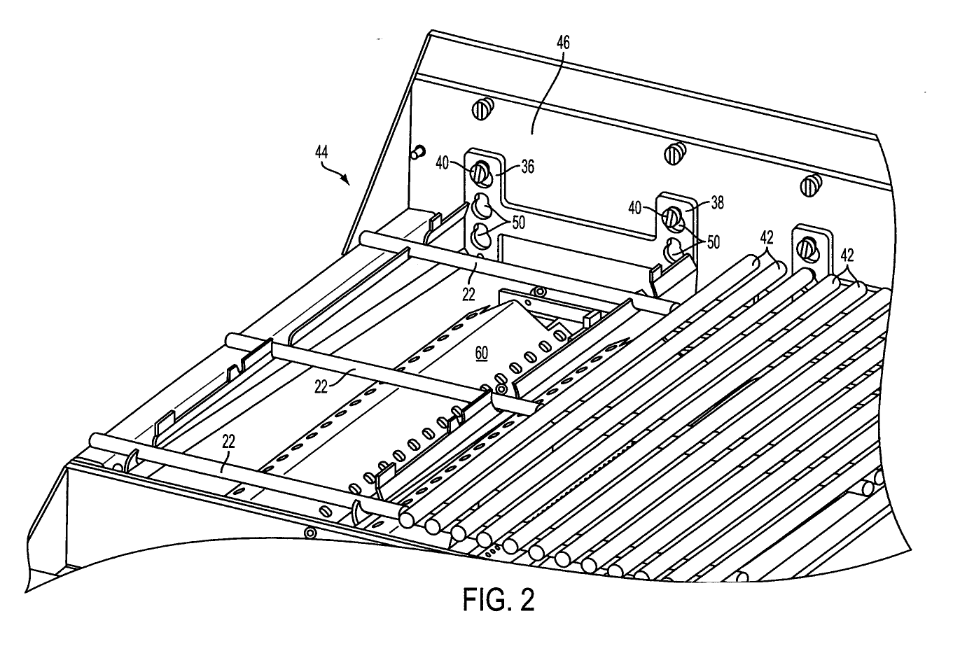

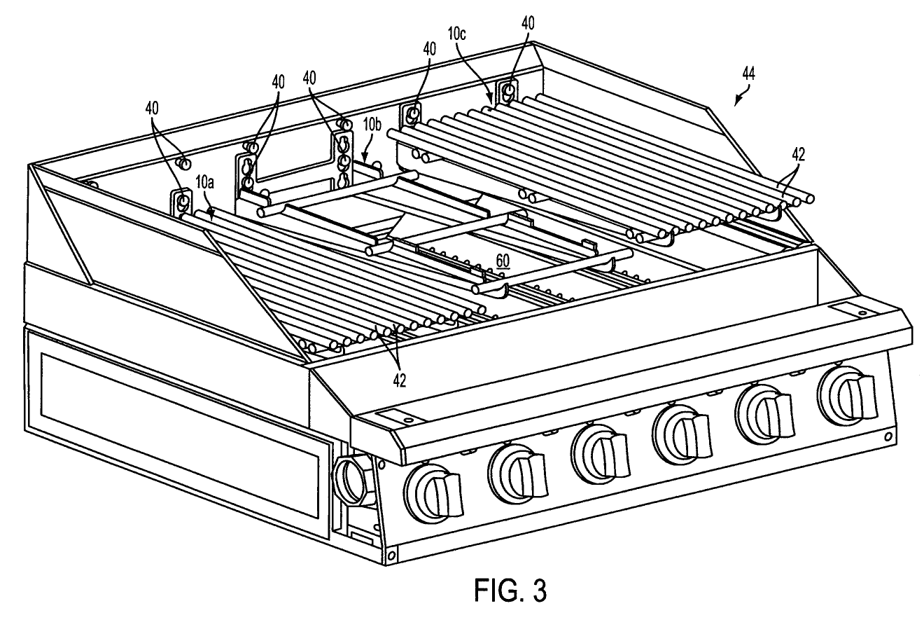

Various support elements (cast iron, bar, diamond, S-shaped grate, fish grate etc.) can be utilized, each with means to secure them to the frame 12. Generally, the frame 12 is constructed of heavy gauge material able to support the weight of the typically heavy grates or bars 42 (FIGS. 2 and 3) in a cantilevered fashion off the rear wall of the range without requiring frontal support. For example, the grates 42 are formed of ribs or bars spaced apart and secured to grate supports or crossbars 22, and can be formed of stainless steel, cast-iron, or other material or blend (for example, at a 0.5-inch diameter). Further, the frame 12 generally is designed with maximum openings between grates 42 to allow maximum flue product flow and penetration through the grate assembly 10, providing maximum heat to the food content and additional secondary air for combustion.

Referring again to FIG. 1, the frame 12 includes two cantilevered supports 24 and 30 that are spaced with first cantilevered support 24 including a first rear support 26 and a first front support 28 and with second cantilevered support 30 including a second rear support 32 and a second front support 34. The first cantilevered support 24 and second cantilevered support 30 taper from the first front supports 28 to the first rear support 26 and from the second front support 34 to the second rear support 32, respectively. The broader/wider bases 26 and 32 provide support for the frame 12. The first cantilevered support 24 acts with and is adjacent a first leg 36 and the second cantilevered support interacts with and is adjacent a second leg 38. The first leg 36 and second leg 38 interact with support mechanisms (such as bolts 40 on a range 44 as shown in FIGS. 2 and 3) to attach the grate assembly 10 to the wall of the range 44. First leg 36 and second leg 38 include bolt receiving holes 50. Three key holes 50 patterned vertically are shown in FIG. 1, but more or less can be included on leg 36 and/or leg 38 as desired. Since a sloped grate surface generally provides uneven surface temperature resulting in uneven cooking, the bolt receiving holes 50 secure the grate assembly 10 in a horizontal orientation a set distance from a burner or other cooking element 60 (FIG. 2) and allow secure attachment and adjustability of the distance from burner 60 if more or less intense cooking heat is desired.

Referring to FIG. 2, the grate is installed in a range 44 cantilevered from a rear vertical wall 46 of the range, with bolt receiving holes 50 of the grate mounted on bolts 40 on rear wall 46. The bolts 40 are disposed on rear wall 46 of the range 44 and support and interact with first leg 36 and second leg 38 to secure the grate in place within range 44. The legs 36 and 38 generally press downward against the char broiler rear wall, supporting the frame to maintain a horizontal surface, cantilevering the frame 12 forward off the rear wall while preventing sagging or slopping of the frame 12. In order to strengthen the frame 12 further, additional gussets (not shown) can be provided to prevent the cantilevered frame from bending downward. Further, the angle of such additional gusset can be formed to compensate (e.g., by orienting such slightly greater than 90 degrees) for any possible bending/deforming due to weight of the grate. The bolts 40 shown in FIG. 2 are shoulder bolts, though the invention should not be limited to such configuration. The grate assembly in FIG. 2 is shown in its lowest position closest to the heat source/burner(s) 60 of range 40 with the top bolt receiving holes 50 receiving bolts 40. The lowest allowable adjustable height (minimum distance for the grate from the burner below) generally should allow adequate secondary air and flue products to exit the firebox, resulting in a complete combustion process. The supports for the grates are cantilevered without front supports and allow adjustment to various heights without the need or use of front supports.

Multiple modular grate frames can be used within a single range firebox to mount at multiple adjustable heights to create different cooking surfaces and temperatures for different food or different cooking requirements. FIG. 3 shows three grates assemblies 10a, 10b, 10c installed in range 44 in three different positions, with the leftmost grate assembly 10a disposed in the lowest position closest burner 60, the middle grate assembly 10b disposed in a middle position further from burner 60 than the leftmost position, and the rightmost grate assembly 10c disposed in the highest position further from burner 60 than the middle position. As shown in FIGS. 2 and 3, grates 42 are supported on frame 12, generally atop support elements 22, and are spaced to receive pots, pans, or other implements for heating by range 44. As an example, if the grate assemblies 10a, 10b, 10c shown in FIG. 3 each had a 12″ width, three separate 12″ wide cooking zones would be provided for a 36″ wide range. Alternatively, if the grate assemblies had, for example, an 18″ width, two separate cooking zones would be provided for a 36″ wide range. Various sizes/widths of grate assemblies can be provided, generally depending on the width of the char broiler, including, for example, 24″, 36″, 48″, 60″, and 72.″

The grate and frame designs shown in the figures are interchangeable between all available grate types detailed. The grates are removable (e.g. for cleaning) and are reversible. The grates can also be mixed to use different types of bars for different type of food on the same range. Further, the modular design of the grates allow fitting into various range sizes, such as from 18 inches up to 72 inches merely by adding more grates and frames.

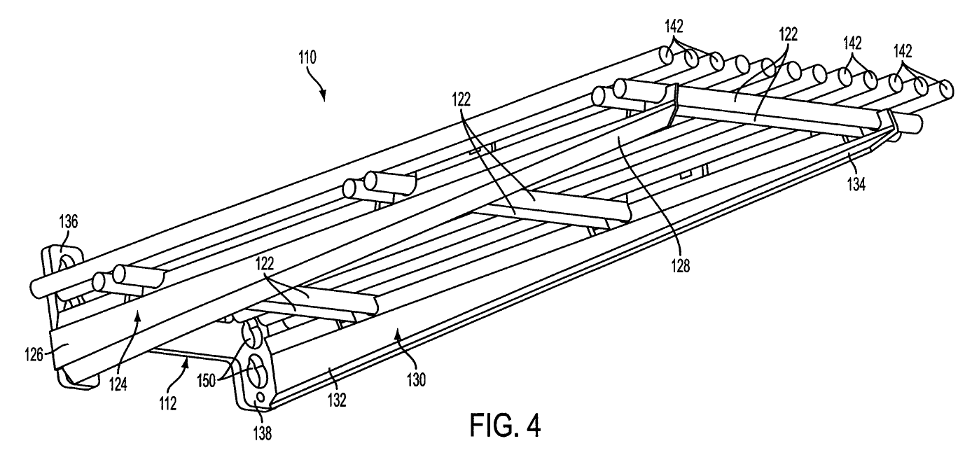

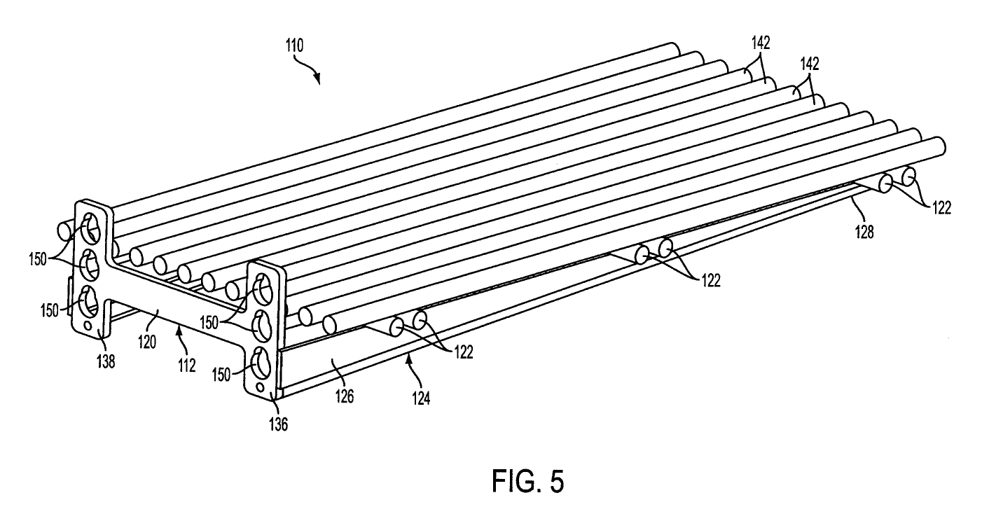

FIG. 4 shows a grate assembly 110 according to a second embodiment. The grate assembly 110 has a frame 112 configured to hold three pairs of support elements 122 that support receiving grates 142 and that secure and space the supports 124 and 130. The frame 112 is supported by two cantilevered supports 124 and 130, with first cantilevered support 124 including a first rear support 126 and a first front support 128 and with second cantilevered support 130 including a second rear support 132 and a second front support 134. The first cantilevered support 124 and second cantilevered support 130 taper from first front supports 128 to first rear support 126 and from second front support 134 to second rear support 132, respectively. The broader/wider rear supports 126 and 132 provide support for the frame 112. The first cantilevered support 124 acts with and is adjacent a first leg 136 and the second cantilevered support interacts with and is adjacent a second leg 138. The first leg 136 and second leg 138 interact with support mechanisms located on a wall of the range to attach the grate assembly 110 for support. As shown in FIG. 4, first leg 136 and second leg 138 include bolt receiving holes 150 (three shown, but more or less can be included on leg 136 or leg 138 as desired). The bolt receiving holes 150 are sized to receive bolts projecting from a wall of a range. The bolt receiving holes 150 allow the grate assembly 110 to be secured in one of three positions (more positions if more holes are included in leg 136 or 138) and allow secure attachment in position in a range and quick adjustability if a varied height is desired, such as while cooking. FIG. 5 shows a topside perspective view of the grate assembly 110 of FIG. 4, showing rear 120 of frame 112.

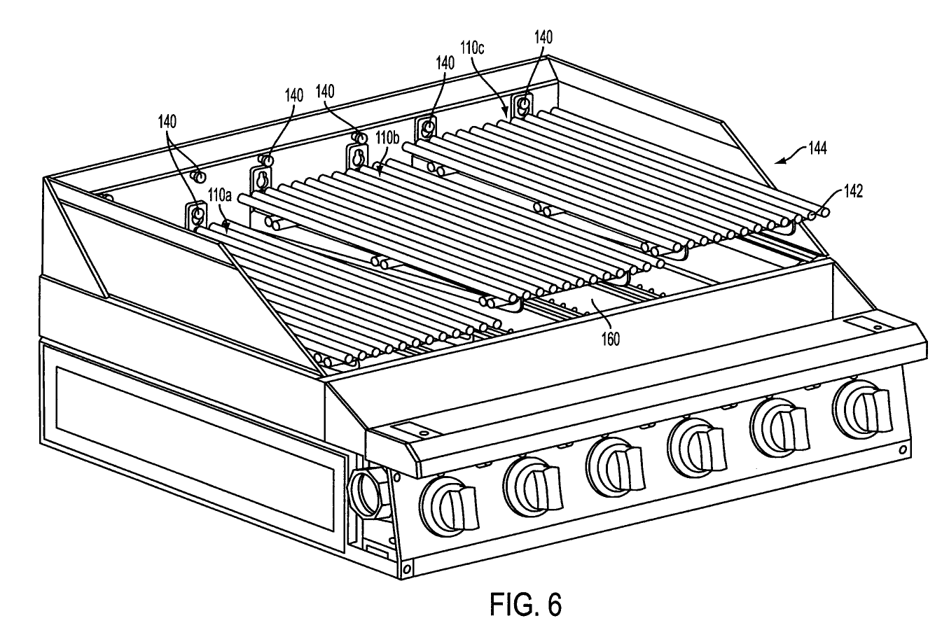

FIG. 6 shows three grate assemblies 110a, 110b, 110c installed in range 144 in three different positions, with the leftmost grate assembly 110a disposed in the lowest position closest burner 160, the middle grate assembly 110b disposed in a middle position further from burner 160 than the leftmost position, and the rightmost grate assembly 110c disposed in the highest position further from burner 160 than the middle position. The grate assemblies 110a, 110b, and 110c are installed in range 144 with bolt receiving holes 150 receiving bolts 140. The bolts 140 are disposed on and project from a rear wall of the range 144 and support and interact with first leg 136 and second leg 138 to secure grate assemblies 110a, 110b, and 110c in place in range 144. As shown in FIG. 6, grates 142 are disposed over frame 112, generally atop support elements 122, and are spaced to receive pots, pans, or other implements for heating by range 144.

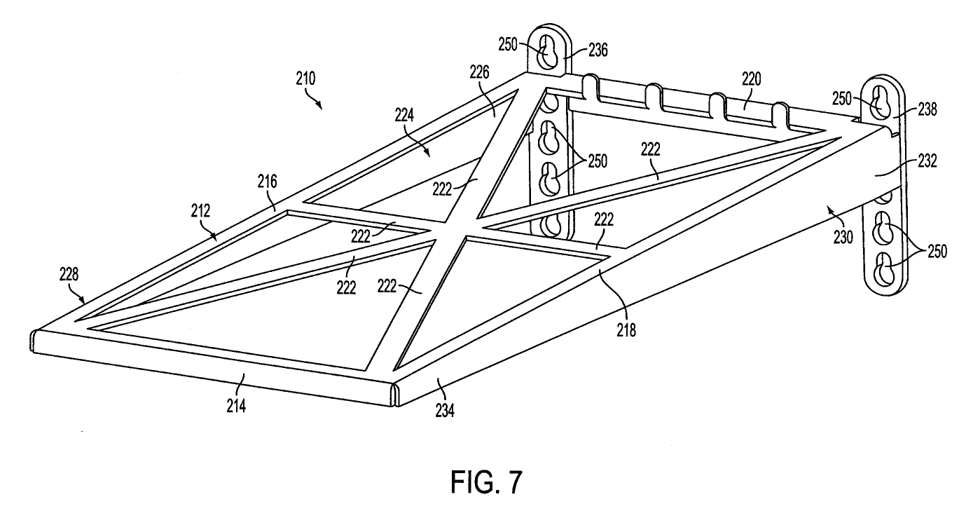

FIG. 7 shows a grate assembly 210 according to a third embodiment. The grate assembly 210 in FIG. 7 includes a frame 212 with a front 214, first side 216, second side 218, and rear 220. Optionally, the frame 212 can include frame support elements, here shown in one configuration at 222. The frame support 222 can be exposed in different configurations and can be interchangeable depending upon, for example, the type and amount of heat to be used or substance to be heated.

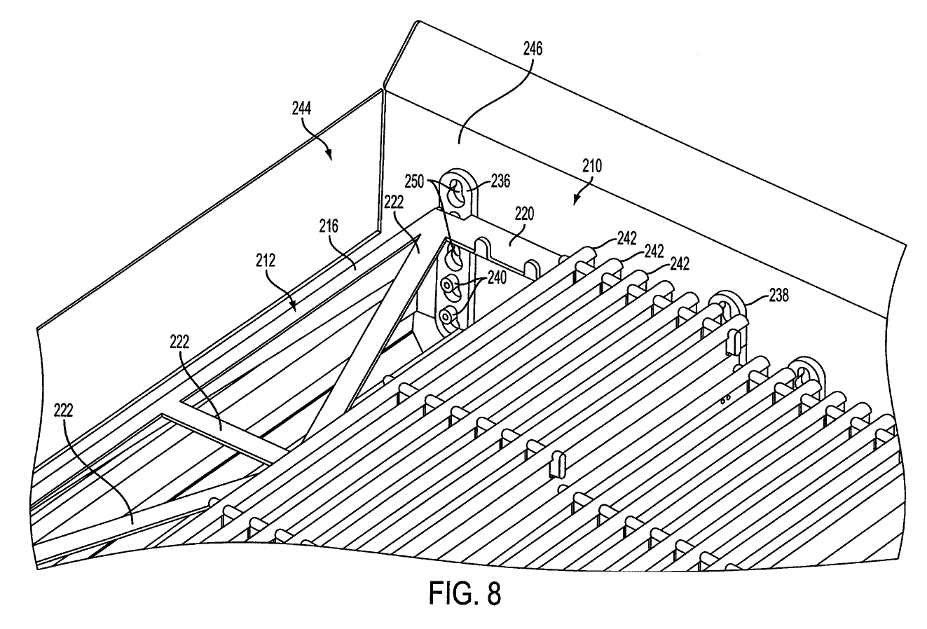

The frame 212 is shown in FIG. 7 supported by two cantilevered supports 224 and 230. First cantilevered support 224 includes a first rear support 226 and a first front support 228. Second cantilevered support 230 includes a second rear support 232 and a second front support 234. As shown in FIG. 7, the first cantilevered support 224 and second cantilevered support 230 taper from the first front supports 228 to the first rear support 226 and from the second front support 234 to the second rear support 232, respectively. The broader/wider rear supports 226 and 232 provide support for the frame 212. The first cantilevered support 224 acts with and is adjacent a first leg 236 and the second cantilevered support interacts with and is adjacent a second leg 238. The first leg 236 and second leg 238 include bolt receiving holes 250 that interact with support mechanisms, such as projecting bolts 240 (FIG. 8), on the range to attach the grate 210 for support.

Referring to FIG. 8, the grate assembly 210 is installed in a range 244 with bolts 240 on and projecting from a rear wall 246 supporting and interacting with bolt receiving holes 250 of first leg 236. Second leg 238 also interacts with other bolts (not shown). Grates 242 are disposed over frame 212 and are spaced to receive pots, pans, or other implements thereon for heating by range 244.

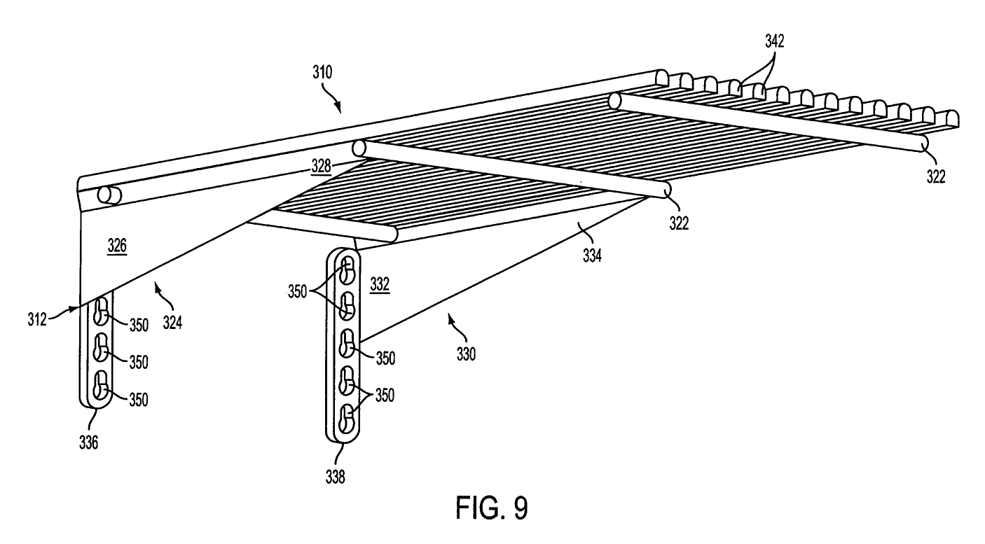

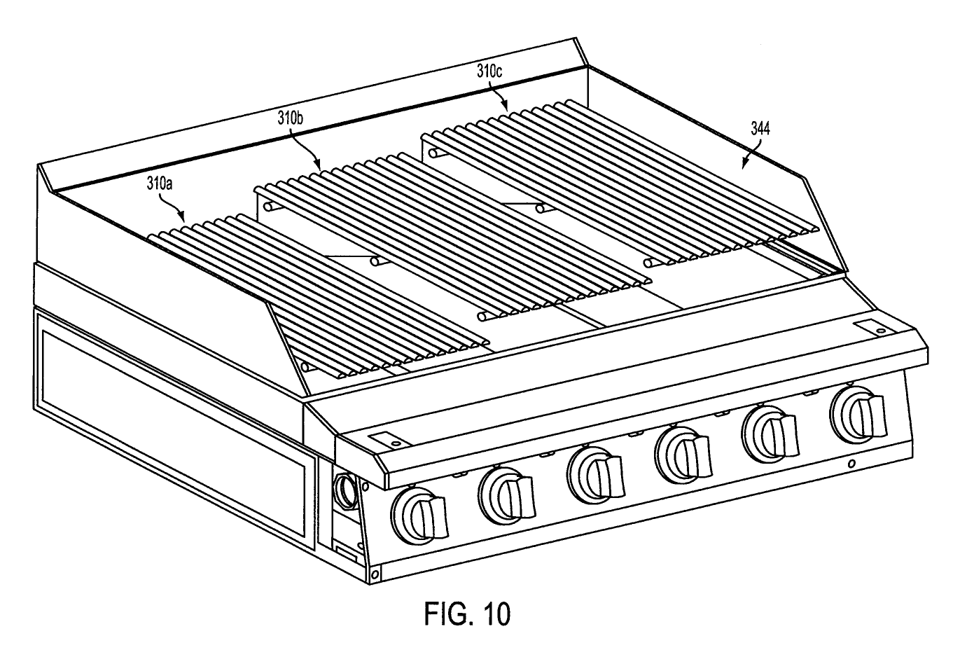

FIG. 9 shows a fourth embodiment of a grate assembly 310 according to the invention. The first and second cantilevered supports 324 and 330 extend only partially along the frame 312, from the rear support 326, 332 to front support 328, 334. In comparison to previous embodiments, rear supports 326, 332 are extended and/or widened to maintain the supports 322, grates 342, and any cooking implement placed thereon in a horizontal position. The first cantilevered support 324 acts with and is adjacent a first leg 336 and the second cantilevered support interacts with and is adjacent a second leg 338. The first leg 336 and second leg 338 include bolt receiving holes 350 that interact with support mechanisms on the range to attach the grate assembly 310 for support. FIG. 10 shows grate assemblies 310a, 310b, and 310c according to the fourth embodiment of FIG. 9 installed in a range 344.

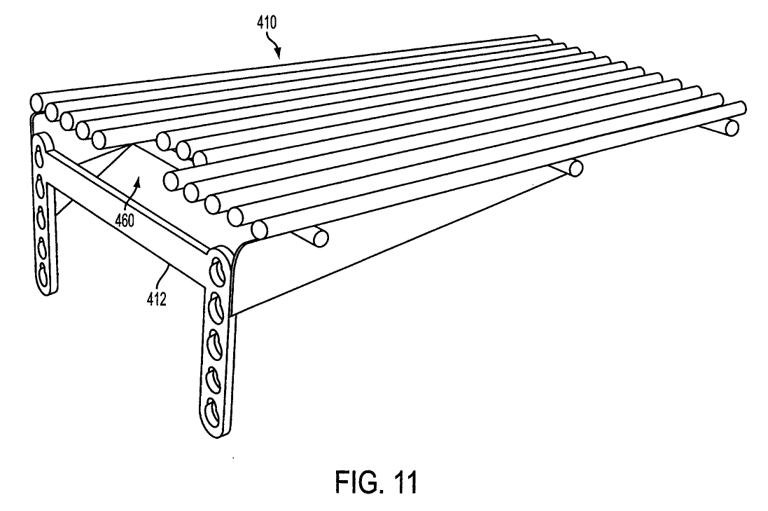

FIG. 11 shows a fifth embodiment of a grate assembly 410 with the grates sized and arranged to provide a finger gap 460 to enable easier removal or installation of grate assembly 410. The finger gap 460 is generally formed by including different length grates or bars in a portion of the grate assembly and is shown in FIG. 11 in a central portion toward the rear 412, though other locations may work similarly well to enable easier removal and installation of the grate assemblies. Finger gaps also can be provided in all other configurations, such as those shown in FIGS. 1-10 and 12.

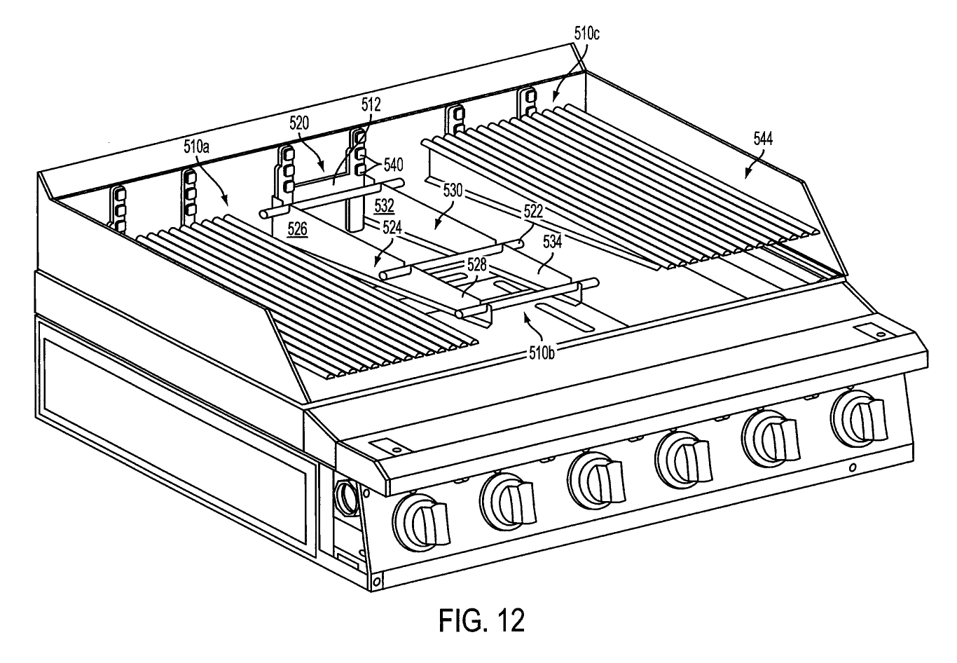

FIG. 12 shows a sixth embodiment of three grate assemblies 510a, 510b, and 510c installed in a range 544. As shown in FIG. 12, the first and second cantilevered supports 524 and 530 extend substantially the entire length of the grates from rear support 526, 532 to front support 528, 534. Additionally, the bolt receiving holes 550 receiving bolts 540 are shown with a square cross-section. The arrangement, configuration, and number of the holes and bolts can be varied as desired.

The grate(s) can be formed of a single piece that can be removable from the grate frame, or integral with the frame. Further, the grate(s) can be formed in two or more pieces to cover the frame. Further still, the bars of the grate(s), generally in cross-section, can be cylindrical, round, square, diamond, rectangular, in teardrop or keyhole shapes, or any other configuration, or combination of configurations, depending upon the desired transfer of heat and can vary per design. If desired, the grate(s) can be formed in a waffle pattern, conical mesh pattern, tear drop pattern, or have slim or wide profiles to produce patterns, sharp points or lines, or other grill type marks on the food being cooked.

The foregoing description of the disclosure illustrates and describes various embodiments of the present disclosure. As various changes could be made in the above construction without departing from the scope of the disclosure, it is intended that all matter contained in the above description or shown in the accompanying drawings shall be interpreted as illustrative and not in a limiting sense. Furthermore, the present disclosure covers various modifications, combinations, and alterations, etc., of the above-described embodiments that are within the scope of the claims. Additionally, the disclosure shows and describes only selected embodiments, but various other combinations, modifications, and environments are within the scope of the disclosure as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

According to common practice, the various features of the drawings discussed herein are not necessarily shown to scale, dimensions of the various features and elements may be expanded or reduced to illustrate more clearly the embodiments of the invention.

What is claimed is:

1. A grate assembly for a range, the grate assembly comprising:
a frame including a first support and a second support coupled to a base;
at least one grate;
the first support and the second support configured to receive at least one support element; and,
the base including at least two bolt receiving holes each sized to receive a bolt disposed on the range for orienting the grate assembly in a generally horizontal orientation in a first position a first distance above a burner on the range.

2. The grate assembly of claim 1 wherein the first support and the second support are cantilevered and extend from the base.

3. The grate assembly of claim 1 wherein the first support and the second support intersect the base and taper from a wider rear support proximate the intersection with the base to a narrower front support distal the intersection with the base.

4. The grate assembly of claim 1 wherein the base includes a first side adjacent the first support and a second side adjacent the second support.

5. The grate assembly of claim 4 wherein the first side of the base and the second side of the base each include at least three bolt receiving holes sized to receive at least one bolt disposed on the range.

6. The grate assembly of claim 4 wherein the first side of the base and the second side of the base each include at least three bolt receiving holes sized to receive at least two bolts per side disposed on the range.

7. The grate assembly of claim 1 wherein at least two support elements are disposed over the first support and the second support.

8. The grate assembly of claim 1 wherein the at least one grate is removable, reversible, and interchangeable with different configurations receivable in adjacent positions on the support elements.

9. The grate assembly of claim 1 wherein the first support and the second support are cantilevered and support the grate assembly without a front support.

10. The grate assembly of claim 1 wherein the grate assembly is adjustable to a second position a second distance above the burner of the range without requiring a front support.

11. The grate assembly of claim 1 wherein more than one grate assembly is included on the range.

12. The grate assembly of claim 11 wherein the range has a width of 18 inches to 72 inches.

13. A method of installing grate assemblies on a range, the method comprising:
providing a first grate assembly, the first grate assembly including:
a frame including a first support and a second support coupled to a base;
at least one grate;
the first support and the second support configured to receive at least one support element; and,
the base including a first bolt receiving hole and a second bolt receiving hole;
passing the first bolt receiving hole over a first bolt and the second bolt receiving hole over a second bolt; and,
securing the grate assembly in a substantially horizontal position a first distance over a first burner.

14. The method of claim 13 wherein the range is sized to receive more than one grate assembly.

15. A range comprising:
a housing including a rear wall;
a fire box and at least one burner in the housing;
the rear wall including at least one first bolt spaced from at least one second bolt;
at least one grate assembly comprising:
a base, a first support, and a second support; the base having a first end spaced from a second end, with the first support proximate the first end and the second support proximate the second end;
at least one bolt receiving opening at the first end and at the second end;
the first support and the second support configured to receive at least one support element therebetween; and,
the at least one grate assembly being installed in a first position with the at least one opening at the first end receiving the at least one first bolt and the at least one opening at the second end receiving the at least one second bolt on the rear wall of the range.

16. The range of claim 15 wherein the at least one bolt receiving opening includes at least three openings at the first end and at the second end.

17. The range of claim 16 wherein the three openings are vertically oriented and equally spaced at the first end and at the second end.

18. The range of claim 17 wherein the at least one grate assembly can receive the at least one first bolt and the at least one second bolt in one of three positions spaced from the burner.

19. The range of claim 18 wherein the at least one grate assembly comprise a first grate assembly and a second grate assembly with the first grate assembly being installed at a first position spaced a first distance from the burner and the second grate assembly being installed at a second position spaced a second distance from the burner.

20. The range of claim 19 wherein the first distance and the second distance are different.

21. The range of claim 20 wherein the first grate assembly is moved from the first distance to the second distance.

22. The range of claim 19 wherein the at least one support element receives a plurality of grates thereupon.
